(19) United States
(12) Patent Application Publication
(10) Pub. No.: US 2012/0206276 A1
(43) Pub. Date: Aug. 16, 2012

(54) ELECTROMECHANICAL TRAFFIC SIGN BOX WITH DOUBLE SWING ADJUSTABLE SOLAR ENERGY DEVICE

(75) Inventor: Shuei-Tian CAI, Taichung City (TW)

(73) Assignee: SAFETY TRAFFIC EQUIPMENT CO., LTD., Taichung City (TW)

(21) Appl. No.: 13/026,414

(22) Filed: Feb. 14, 2011

(51) Int. Cl. G08G 1/095

(52) U.S. Cl. 340/907

(57) ABSTRACT

An electromechanical traffic sign box with double swing adjustable solar energy device is specifically assembled onto the top section of the support bar of the main body, so as to accommodate the circuit controller and battery. The solar energy device is assembled onto the box's main body and has not only the photovoltaic panel and rack, but also vertical and transverse swing adjusting mechanisms, thus enabling vertical and transverse swinging and positioning of the photovoltaic panel. The sign box enables more flexible assembly and adjustment of the solar energy device in tune with a variety of assembly states and a single box's main body can accommodate the circuit controller and battery, while the solar energy device is assembled onto the box's main body, thus simplifying and saving the circuit assembly cost, reducing exposure to external vandalism and weathering while extending service life with better applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an electromechanical traffic sign box, and more particularly to an innovative one which has a double swing adjustable solar energy device.

2. Description of Related Art Including Information Disclosed Under 37 CFR 1.97 and 37 CFR 1.98

For the purpose of energy conservation and environmental protection, more and more traffic marks and symbols (collectively referred to as traffic signs) are equipped with a solar energy device, which is used to energize LED light-emitting parts on the traffic signs.

If the traffic sign is equipped with the solar energy device, there is a crucial technology concern of how to bring the role of the solar energy device into full play. Yet, some problems and shortcomings still exist for the solar energy device assembled onto the conventional traffic signs. For example, the photovoltaic panel of a solar energy device on certain conventional mechanisms is designed with a fixed angle, or a free angle that can only be adjusted axially. However, some problems may occur since the support bar of the traffic sign is fixed. After the solar energy device is assembled securely onto the support bar of the traffic sign, the photovoltaic panel cannot be adjusted, or can only be adjusted axially, making it difficult to match the assembly angle of the solar energy device or make accurate angular adjustment for an optimized angle to obtain optimum solar power generation effects.

Moreover, if a conventional traffic sign is equipped with a solar energy device, the electromechanical box and solar energy device are distributed in a disorderly manner, making it hard to reduce the exposure to external vandalism and weathering with shorter service life.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

Based on the unique structural configuration of the present invention, the “electromechanical traffic sign box with double swing adjustable solar energy device” allows the electromechanical box's main body to accommodate the circuit controller and battery. Said double swing adjustable solar energy device is assembled onto the electromechanical box's main body, and composed of a vertical swing adjusting mechanism and transverse swing adjusting mechanism. As compared with prior art, the electromechanical traffic sign box enables more flexible assembly and adjustment of the solar energy device in tune with a variety of assembly states. A single electromechanical box's main body can be used to accommodate the circuit controller and battery, while the solar energy device is assembled onto the electromechanical box's main body, thus simplifying and saving the circuit is assembly cost, reducing the exposure to external vandalism and weathering while extending the service life.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the assembled preferred embodiment of the present invention.

FIG. 2 is an exploded perspective view of the preferred embodiment of the present invention.

FIG. 3 is a partially enlarged view of the present invention.

FIG. 4 is a schematic view wherein the double swing adjustable solar energy device of the present invention is under an adjustment state.

FIG. 5 is another schematic view wherein the double swing adjustable solar energy device of the present invention is under an adjustment state.

FIG. 6 is an isolated view of a preferred embodiment wherein the upper section of the electromechanical box's main body of the present invention is configured into an oblique plane.

FIG. 7 is another schematic view of the preferred embodiment showing the assembly state of the electromechanical box's main body of the present invention.

### DETAILED DESCRIPTION OF THE INVENTION

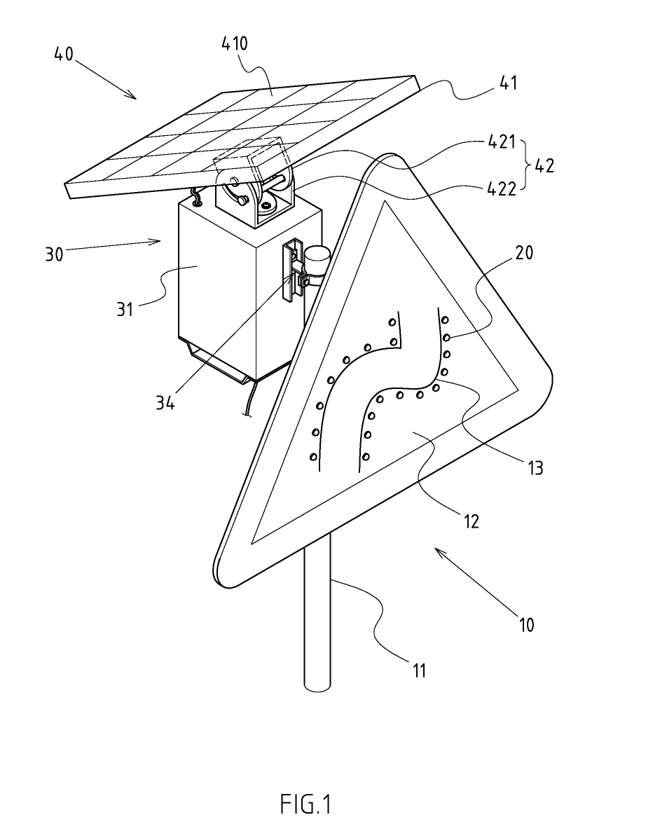

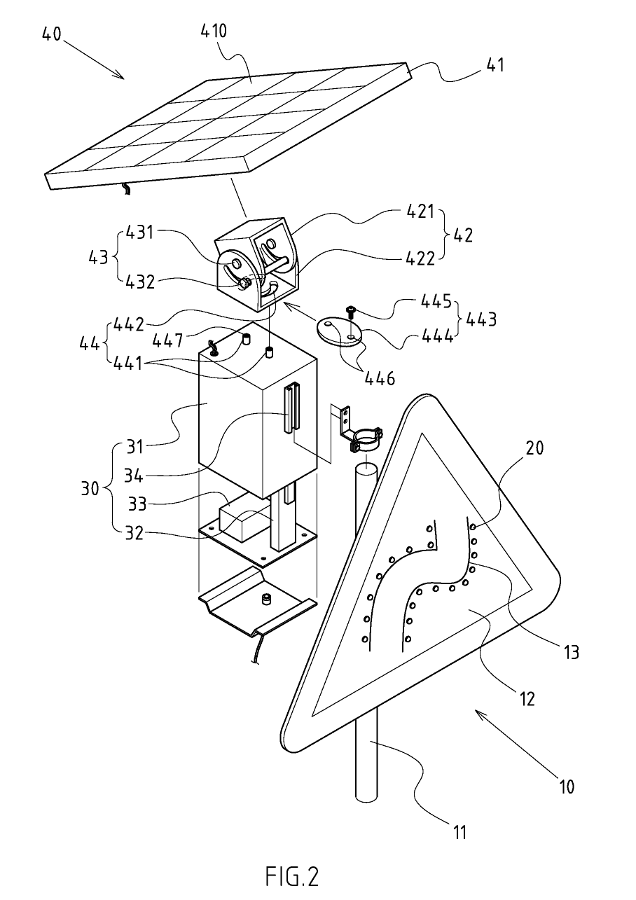

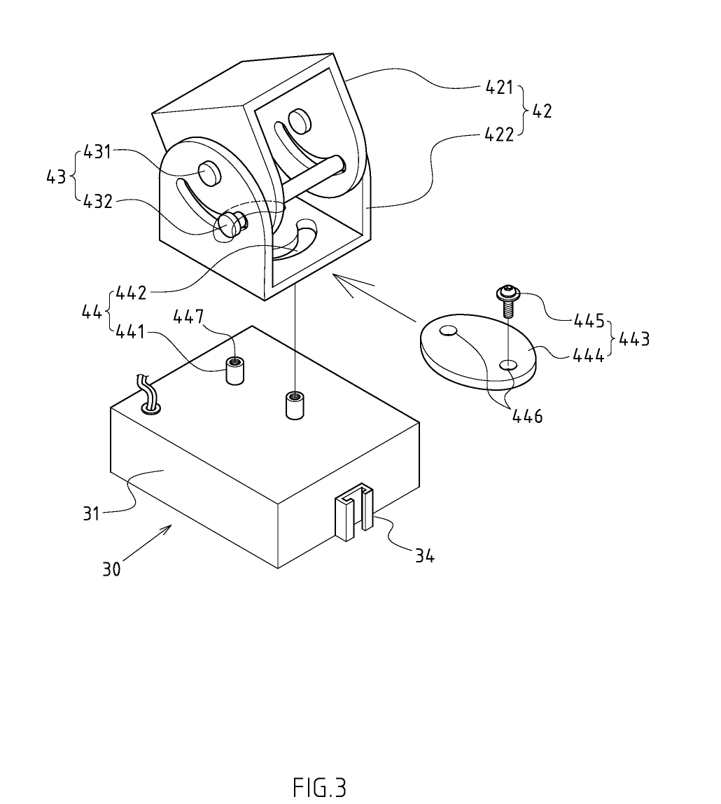

FIGS. 1-4 depict preferred embodiments of an electromechanical traffic sign box of the present invention with double swing adjustable solar energy device, which, however, are provided for only explanatory objective for patent claims. Said electromechanical traffic sign box is specifically assembled onto the support bar 11 of existing main body 10. At least a traffic sign surface 12 is positioned on the support bar of said main body 10. The traffic sign surface 12 is provided with either graphic symbol (shown in FIG. 1) or lamp signal. The support bar 11 of the preferred embodiment is available with a single bar. Besides, the traffic sign surface 12 of the main body 10 is provided with LED luminous bodies 13 generating light-emitting effects. The number of the LED luminous bodies 20 is not limited.

Said electromechanical traffic sign box includes an electromechanical box's main body 30, assembled onto top of the support bar 11 of the main body 10. The electromechanical box's main body 30 has a hollow box 31 as well as a circuit controller 32 and a battery 33 set in the hollow box 31. An assembly portion 34 is set laterally onto the electromechanical box's main body 30 for positioning onto the top of the support bar 11.

A double swing adjustable solar energy device 40 is set externally onto upper section of the electromechanical box's main body 30, having a photovoltaic panel 41 with an illuminated surface 410; a rack 42, used to assemble the photovoltaic panel 41 onto the electromechanical box's main body 30, and comprising of a top frame 421 and a bottom frame 422. The top frame 421 is used for assembling the photovoltaic panel 41, and the bottom frame 422 used for assembling onto the electromechanical box's main body 30. A vertical swing adjusting mechanism 43 is set between the top frame 421 and bottom frame 422 of the rack 42. The vertical swing adjusting mechanism 43 has a rotating axle 431 and an angle locator 432 (screwing by bolts with screw caps), enabling vertical swinging to adjust the inclination angle of the top frame 421 of the rack 42 along with the photovoltaic panel 41 by taking the rotating axle 431 as the pivot, and also locating their angular state by using the angle locator 432. A transverse swing adjusting mechanism 44 is set onto the bottom frame 422 of the rack 42 correspondingly with the electromechanical box's main body 30. The transverse swing adjusting mechanism 44 has two spacing convex studs 441, two symmetrical spacing semi-circular guide holes 442 and a locator 443, of which two convex studs 441 penetrate separately these two semi-circular guide holes 442, such that the convex studs 441 can shift along the path of the semi-circular guide hole 442, and then are fixed by the locator 443, thus permitting transverse swinging and positioning of the rack 42 along with the photovoltaic panel 41.

Of which, two convex studs 441 of the transverse swing adjusting mechanism 44 can be protruded from the upper section of the electromechanical box's main body 30, while two semi-circular guide holes 442 are set correspondingly with the bottom frame 422 of the rack 42. The locator 443 has a press plate 444 and two bolts 445, of which the press plate 444 is provided with two through-holes 446 for penetration of two convex studs 441 of the transverse swing adjusting mechanism 44. A screw hole 447 is also set recessedly on the end surface of two convex studs 441 for screwing of the bolt 445.

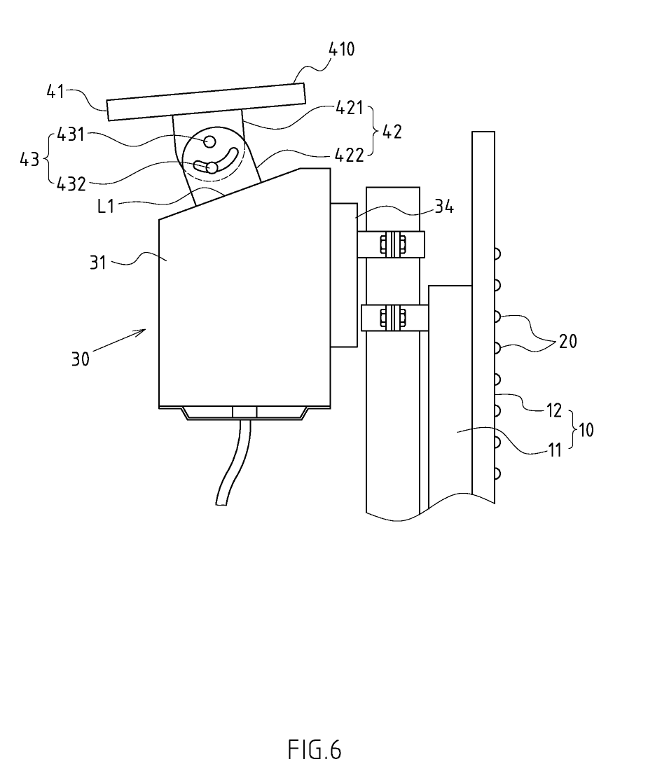

Of which, the upper section of the electromechanical box's main body 30 for assembly of the double swing adjustable solar energy device 40 can be configured into a horizontal plane as disclosed in FIGS. 1-4, or configured into an oblique plane (marked by arrow L1) as disclosed in FIG. 6, or a stepped plane.

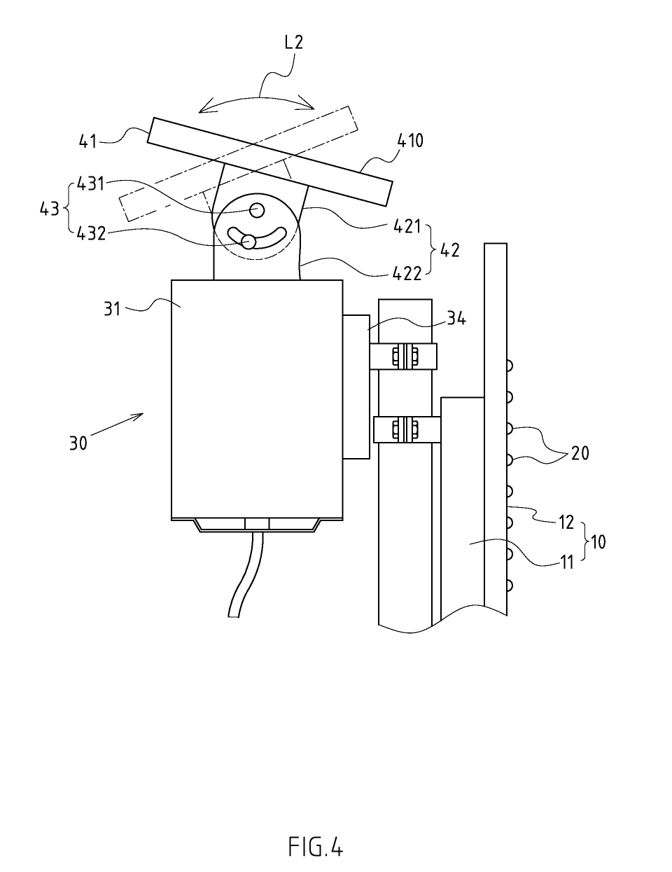

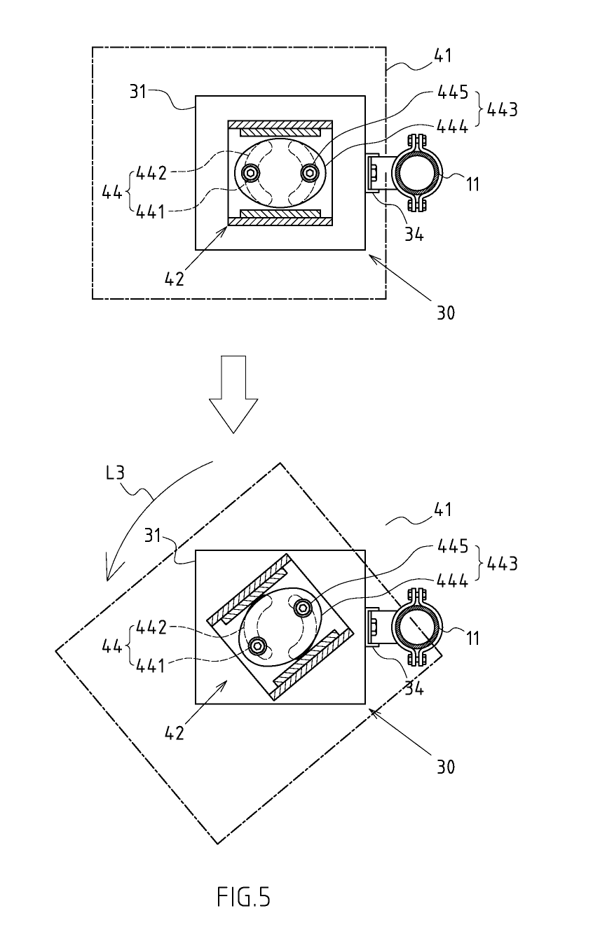

The core aspect of the electromechanical traffic sign box of the present invention lies in that, a double swing adjustable solar energy device 40 is set externally onto upper section of the electromechanical box's main body 30, and provided with a vertical swing adjusting mechanism 43, as disclosed in FIG. 4, this enables vertical swinging to adjust the inclination angle of the top frame 421 of the rack 42 along with the photovoltaic panel 41 by taking the rotating axle 431 as the pivot (marked by arrow L2), and also locating their angular state by using the angle locator 432. Referring also to FIG. 5, with the setting of the transverse swing adjusting mechanism 44, the convex studs 441 can shift along the path of the semi-circular guide hole 442, thus permitting transverse swinging of the photovoltaic panel 41 (marked by arrow L3). Meanwhile, the convex studs 441 are fixed by the locator 443. Hence, the photovoltaic panel 41 of the double swing adjustable solar energy device 40 for the traffic sign of the present invention can be assembled with transverse and vertical swinging for flexible adjustment in different assembly states.

The second core aspect of the electromechanical traffic sign box of the present invention lies in that, a single electromechanical box's main body 30 is used to accommodate the circuit controller 32 and battery 33, and the double swing adjustable solar energy device 40 is directly assembled onto upper section of the electromechanical box's main body 30, so as to shorten the assembly path of the circuit, reduce the exposure to external vandalism and weathering, and contribute to extend greatly the service life of the traffic sign.

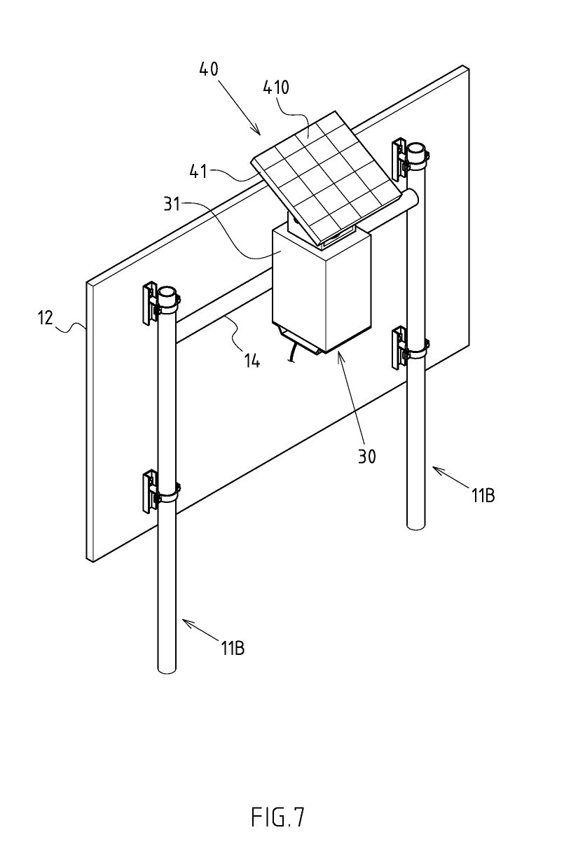

Referring also to FIG. 7, another preferred embodiment showing the assembly state of electromechanical box's main body 30, wherein the support bar 11B is has two spacing bars, between top section of which a cross rod is 14 linked, such that the electromechanical box's main body 30 is assembled securely onto the cross rod 14.

1. An electromechanical traffic sign box with double swing adjustable solar energy device, specifically assembled onto the support bar of existing main body; the electromechanical traffic sign box comprising:
an electromechanical box's main body, assembled onto top of the support bar of the main body; the electromechanical box's main body has a hollow box as well as a circuit controller and a battery set in the hollow box; an assembly portion is set laterally onto the electromechanical box's main body for positioning onto the top of the support bar;
a double swing adjustable solar energy device, set externally onto upper section of the electromechanical box's main body, comprising of:
a photovoltaic panel with an illuminated surface;
a rack, used to assemble the photovoltaic panel onto the electromechanical box's main body, and comprising of a top frame and a bottom frame; the top frame is used for assembling the photovoltaic panel, and the bottom frame used for assembling onto the electromechanical box's main body;
a vertical swing adjusting mechanism, set between the top and bottom frames of the rack; the vertical swing adjusting mechanism has a rotating axle and an angle locator, enabling vertical swinging to adjust the inclination angle of the top frame of the rack along with the photovoltaic panel by taking the rotating axle as the pivot, and also locating their angular state by using the angle locator;
a transverse swing adjusting mechanism, set onto the bottom frame of the rack correspondingly with the electromechanical box's main body; the transverse swing adjusting mechanism has two spacing convex studs, two symmetrical spacing semi-circular guide holes and a locator, of which two convex studs penetrate separately these two semi-circular guide holes, such that the convex studs can shift along the path of the semi-circular guide hole, and then are fixed by the locator, thus permitting transverse swinging and positioning of the rack along with the photovoltaic panel.

2. The structure defined in claim 1, wherein two convex studs of the transverse swing adjusting mechanism of the double swing adjustable solar energy device can be protruded from the upper section of the electromechanical box's main body, while two semi-circular guide holes are set correspondingly with the bottom frame of the rack; the locator has a press plate and two bolts, of which the press plate is provided with two through-holes for penetration of two convex studs of the transverse swing adjusting mechanism; and a screw hole is also set recessedly on the end surface of two convex studs for screwing of the bolt.

3. The structure defined in claim 1, wherein the upper section of the electromechanical box's main body for assembly of the double swing adjustable solar energy device can be configured into either of a horizontal plane, or an oblique plane or a stepped plane.

4. The structure defined in claim 1, wherein at least a traffic sign surface is positioned on the support bar of said main body; the traffic sign surface is provided with either graphic symbol or lamp signal; moreover, the traffic sign surface of the main body is provided with LED luminous bodies.
